(19) United States
(12) Patent Application Publication
(10) Pub. No.: US 2015/0228361 A1
(43) Pub. Date: Aug. 13, 2015

(54) Converter Reactor for Thermal Neutrons

(71) Applicant: Alexander Potemkin, Barsbuettel (DE)

(72) Inventor: Alexander Potemkin, Barsbuettel (DE)

(21) Appl. No.: 14/367,692

(22) PCT Filed: Dec. 21, 2011
(86) PCT No.: PCT/IB2011/003220

§ 371 Date: Mar. 4, 2015

(51) Int. Cl. G21C 1/22; G21C 3/52

(52) U.S. Cl. CPC G21C 1/22; G21C 3/52

(57) ABSTRACT

A converter reactor is provided. The converter reactor includes a low-pressure housing in which an active zone of the reactor is located. The reactor includes vertical columns of a side reflector and a moderator, channels for heat carrier flow and fuel elements having fuel rods in the central openings of the moderator columns. The low-pressure housing is made of a high-strength titanium alloy with an inner protective boron nitride composite material. The heat carrier in which the active zone is immersed is polysilazane-based. The interior of the fuel rods is filled with a uranium-plutonium melt. Cavities of the upper ends of the fuel rods communicate with fuel element cavities and fission product collectors of the fuel elements at the same pressure.

The invention belongs to the field of nuclear energy technology and relates to the development of a converter reactor for thermal neutrons with a molten uranium-plutonium fuel having a mean nuclear conversion rate ensuring the provision with fuel in a self-sustaining manner. The converter reactor for thermal neutrons in a channel design consists of a low pressure housing in which the active zone is located that consists of the vertical columns of the side reflector and the moderator, wherein the technological channels (TK) for the flow of the heat carrier are set into the central openings of the moderator columns, and the fuel elements (TVS) with the fuel rods (TVEL) are accommodated in the heat carrier. The low pressure housing of the reactor is made of a high-strength titanium alloy equipped with a protective boron nitride composite material and filled with a polysilazane based heat carrier into which the active zone is immersed. The interior of the fuel rods of the fuel elements accommodated in the technological channels of the moderator is filled with the uranium-plutonium melt. The upper ends of the fuel rods are brought together in the fission product collectors of the fuel elements. The ends of the fuel rods communicate with the cavity of the fuel element, said cavity communicating with the open cavity above the fuel which has the same pressure as the cavity. In the proposed reactor design, a low-level enriched mixture of fertile material and fissionable uranium and plutonium isotopes is used in which the maximum portion of fissionable isotopes is as high as in the spent fuel (OJaT) from light-water reactors, and therefore the reactor does not require any products from an outer fuel cycle.

The sodium-graphite rector SGR is known (Nebraska, U.S.A., P.A., Lavrov. Jadernye ėnergeti\check{c}eskie ustanovki (nuclear energy plants). Gosėnergoizdat. Moskow 1958, page 209).

The reactor for thermal neutrons in a channel design consists of a low pressure housing in which the active zone is located which consists of the vertical columns of the side reflector and the moderator, wherein the technological channels (TK) for the flow of the heat carrier are set into the central openings of the moderator columns, in which technological channels, in turn, the fuel elements (TVS) having the fuel rods (TVEL) are accommodated.

The fuel is metallic uranium alloyed with molybdenum, enriched to 3% and having a nuclear conversion ratio of about 0.7. The graphite moderator consists of hexagonal blocks in zirconium shells having a thickness of 0.9 mm to protect the graphite from being soaked with the sodium. The fuel rods are disposed in shells made of stainless steel having a thickness of 0.25 mm. The good thermal contact between the fuel element core made of uranium and the shell is achieved by filling the gap therebetween with liquid sodium or sodium-potassium. The upper part of the shell is filled with helium. The reactor housing and the supports are made of stainless steel. The heat carrier (sodium) is fed from the lower part of the reactor housing via the tubes of the technical channels and through the 11.25 mm large intermediate spaces between the graphite blocks. Said reactor has the following drawbacks:
1. The stainless steel of the fuel rod shells only fails to react with the uranium up to a temperature of 650° C.
2. The protective zirconium shell on the graphite blocks is a parasitic neutron absorber.
3. During the operation, the solid uranium accumulates fission products which absorb neutrons and poison the reactor, which when the fuel melts results in a sudden pressure increase, in the escape of gaseous products and a reactivity excursion.
4. In the case of uranium there are various phase conversions with different packing densities. As a result, it has a tendency towards distortions and the formation of eutectic reactions with the fission products accumulated therein in the case of temperature changes.
5. The hermetic seal of the fuel rod prevents the removal of the volatile and gaseous fission products, which increases the pressure in the shell interior and, when the fuel melts, results in the destruction thereof and in the ejection of the fission products into the heat carrier.
6. When the readily melting sodium (boiling point 883° C.) contacts the molten uranium-plutonium fuel, it reacts with the oxygen and nitrogen dissolved in the fuel so as to release a large amount of heat due to the exothermal character of the reactions. As a result, the sodium becomes radioactive and the systems and the conducts of the reactor are “contaminated”, i.e. the radioactivity is increased.
7. The materials of the active zone of the reactor have a large absorption cross-section, and therefore the obtained nuclear conversion ratio is not sufficient to provide the reactor with nuclear fuel in a self-sustaining manner.

Taking into account its technical principle, the converter reactor utility model 56048 of May 3, 2006 is closest to the proposed invention. In said utility model, the fuel rod consists of a composite material comprising 95-80% by volume of ¹¹B¹⁵N and 5-20% by volume of β-SiC whiskers and, during the operation, is in contact with liquid uranium-plutonium fuel and ⁷Li heat carrier. The upper ends of the fuel rods communicate with the cavity of the fuel element and the cavity via the fuel and the gas cushion of the reactor, via which the readily volatile fission products are constantly separated while the collector is equipped with a reservoir for the neutron absorbing non-volatile fission products.

A prototype of said converter reactor shows the following drawbacks:
1. Low strength values of the fuel rod crucibles made of hexagonal boron nitride equipped with β-SiC nano wires, in particular in the case of impact strength and fire resistance,
2. high degree of affinity of the lithium heat carrier for oxygen and nitrogen in the case of large reaction exothermicity, which can result in a temperature increase in the fuel element that cannot be controlled,
3. the fission product collector for the readily volatile products and those having a low vapor pressure is not fixed either structurally or on account of the type of material,
4. there is no proposal for a mechanism for evacuating the fission products from the converter reactor both structurally and also according to the material used,
5. the steel low pressure housing which must receive the defects resulting in the reactor operation, shows an increased susceptibility to aerosols, escaping via flow-offs resulting from dislocations, micro cracks etc., of the heat carrier ⁷Li.

The object of this invention is to create a converter reactor which operates with liquid uranium-plutonium fuel and in which the mean nuclear conversion ratio of the fuel is sufficient for a provision with fuel in a self-sustained manner and which is free from the above mentioned deficiencies. The technical solution resulting from the invention consists in using in the proposed reactor design a low-level enriched mixture of fertile material and fissionable uranium and plutonium isotopes, the maximum amount of fissionable isotopes in said mixture being as large as in the spent fuel (OJaT) from light water reactors, and therefore the reactor does not require any products from an outer fuel cycle.

The object as set is achieved as follows. The converter reactor of channel design has a low pressure housing made from a high-strength titanium alloy which does not become radioactive during the reactor operation, an active zone accommodated in this housing which consists of the vertical columns of the side reflector and the moderator, wherein in the central openings of the moderator columns the technological channels (TK) for the flow of the heat carrier are set, in which technological channels, in turn, the fuel elements (TVS) with the fuel rods (TVEL) are accommodated. The housing is protected from the inside with a boron nitride composite material. The upper ends of the fuel rods are joined in the fission product collector of the fuel element. The moderator and the reflector are made from an ¹¹B¹⁵N-based nanostructured composite material, reinforced with nano wires made from β-SiC and nanodispersive particles of cubic ¹¹B¹⁵N and enriched with helium. The fission product collector of the fuel element contains both a nanoporous sorption material for the extraction of gaseous products as well as those having a high vapor pressure from the surface of the uranium-plutonium melt and a sorption material for the fission products having a low vapor pressure, which has a low energy turnover upon the formation of solid solutions, of displacement and incorporation mixed crystals and the like, the affinity of which for the absorbent being much higher than that for the fuel melt. The fuel elements with the fuel rods are accommodated in the technological channels, wherein the fuel elements are crucibles having dead lower and open upper ends, the interiors of which accommodate the uranium-plutonium melt at a temperature of 700-1150° C. and the polysilazane-based heat carrier being disposed on the outside. The proposed invention solves the most important problems involved in the nuclear energy production:
nuclear safety: no high pressure in the heat carrier of the primary circuit, low reactivity excess at the beginning, homogeneity of the fuel over the entire volume, high thermal inertia of the active zone, minimum fuel wastes,
radiation safety: no induced radioactivity of the polysilazane serving as a heat carrier, low radioactivity of the fuel, constant removal of the fission products from the active zone,
almost complete utilization of the fission and breeding components of the fuel, i.e. an essential reduction in the spent fuels to be disposed of,
low initial enrichment: no overload of the reactor; the closed fuel circuit without external production solves the problem of the non-distribution of nuclear weapons.

1-5. (canceled)

6. A converter reactor, comprising:
a low-pressure housing;
an active zone of the reactor located in the housing, the active zone of the reactor including
vertical columns of a side reflector,
vertical columns of a moderator,
technological channels flow of a heat carrier, the heat carrier technological channels being located in central openings of the moderator columns,
fuel elements having fuel rods located in the heat carrier technological channels, wherein upper ends of the fuel rods of each fuel element communicate with a cavity of said fuel element,
wherein
the low-pressure housing of the reactor comprises a titanium alloy and an inner layer of a boron nitride composite material and is filled with the heat carrier into which the active zone is immersed,
an interior of the fuel rods of the fuel elements in the technological channels of the moderator contains reactor fuel and a cavity above the reactor fuel,
upper ends of the fuel rods communicate with cavities of the fuel element and with fission product collectors of the fuel elements,
the fission product collectors of the fuel elements contains a nanoporous sorption material configured to extract gaseous products and products having a high vapor pressure and a sorption material configured to extract fission products having a low vapor pressure.

7. The converter reactor for thermal neutrons according to claim 6, wherein shells of the fuels rods, fuel elements, technological channels and the moderator comprise an ¹¹B¹⁵N-based nanostructured composite material enriched with helium, the nanostructured composite material being a material reinforced with nano wires made of β-SiC and nanodispersive particles made of cubic ¹¹B¹⁵N with a composition of
¹¹B¹⁵N 93-79% by volume
cubic ¹¹B¹⁵N 1-3% by volume
β-SiC 5-15% by volume
He 1-3% by volume.

8. The converter reactor for thermal neutrons according to claim 6, wherein the heat carrier is a polysilazane heat carrier having a stoichiometric composition of Si₃¹⁵N₃C₁₂D₂₂.

9. The converter reactor for thermal neutrons according to claim 6, wherein the nanoporous sorption material configured to extract gaseous products and products having a high vapor pressure includes an SiAlON-based nanoporous sorbent.
